(19) United States
(12) Patent Application Publication
(10) Pub. No.: US 2023/0237239 A1
(43) Pub. Date: Jul. 27, 2023

(54) CIRCUIT UNIT HAVING ADJUSTABLE DRIVING STRENGTH CAPABILITY IN CHIP AND METHOD THEREOF

(71) Applicant: Cortina Access, Inc., San Jose, CA (US)

(72) Inventor: Sebastian Havluj Ziesler, San Jose, CA (US)

(21) Appl. No.: 17/583,436

(22) Filed: Jan. 25, 2022

(51) Int. Cl. G06F 30/3953; G06F 30/392

(52) U.S. Cl. CPC G06F 30/3953; G06F 30/392; G06F 2119/06

(57) ABSTRACT

A circuit unit in a chip includes a main circuit portion and a configurable portion. The configurable portion includes an output stage, a plurality of configurable stages, and a configurable metal layer. The configurable stages are configured to be connected in sequence to the output stage. The configurable metal layer is connected to the output stage. The main circuit portion is configured to be adjacent to and connected to the output stage of the configurable portion. A driving strength of the circuit unit is determined based on a connection relationship between each of the plurality of configurable stages and the configurable metal layer.

### BACKGROUND

### Technical Field

The disclosure relates to an integrated circuit, and in particular, to a circuit element having an adjustable driving strength capability in an integrated circuit.

### Related Art

The engineer change order (ECO) technology is quite important for design and production of chips. After an initial layout of a chip, the ECO is usually used to correct an error and/or to and an additional function in the initial layout of the chip. Therefore, during the initial layout of the chip, some ECO elements are designed in an unused layout region. These ECO elements are elements that have no function but have a transistor-like structure (for example, a dummy transistor), to meet a requirement of a subsequent possible ECO. An integrated circuit is formed by overlapping multilayer metal and multilayer poly. Therefore, if the ECO only changes one metal layer, the benefits on time and cost control can be achieved.

However, because a physical location of a filled ECO element is not as close to a to-be-connected circuit unit as when whole-layer modification is implemented, a timing requirement of the circuit unit cannot be met even if the ECO element is used. For example, a layout path of a circuit unit in an initial chip just meets a timing requirement. When an ECO element needs to be added to this layout path later, the added ECO element causes the new layout path of the circuit unit to fail in meeting the timing requirement (due to the time delay of the long wire). As a result, the timing of the entire layout path slows down, and the entire layout path no longer meets the needed timing requirement.

### SUMMARY

The disclosure provides a circuit unit located in a chip. In an embodiment, the circuit unit has an adjustable driving strength capability. The circuit unit includes a main circuit portion and a configurable portion. The configurable portion includes an output stage, a plurality of configurable stages, and a configurable metal layer. The configurable stages are configured to be connected in sequence to the output stage. The configurable metal layer is connected to the output stage. The main circuit portion is configured to be adjacent to and connected to the output stage of the configurable portion. A driving strength of the circuit unit is determined based on a connection relationship between each of the plurality of configurable stages and the configurable metal layer.

The disclosure further provides a method for determining a driving strength of a circuit unit. In an embodiment, the method includes: providing a main circuit portion of the circuit unit; providing a configurable portion of the circuit unit, wherein the configurable portion comprises an output stage, a plurality of configurable stages, and a configurable metal layer, and wherein the configurable stages are configured to be connected in sequence to the output stage, and the configurable metal layer is connected to the output stage; wherein the main circuit portion is configured to be adjacent to and connected to the output stage of the configurable portion; and determining the driving strength of the circuit unit according to a connection relationship between each of the configurable stages and the configurable metal layer.

Detailed features and advantages of the disclosure are described in detail in the following implementations, and the content of the implementations is sufficient for a person skilled in the art to understand and implement the technical content of the disclosure. A person skilled in the art can easily understand the objectives and advantages related to the disclosure according to the contents disclosed in this specification, the claims and the drawings.

### BRIEF DESCRIPTION OF THE DRAWINGS

FIG. 1 is a schematic block outline diagram of an embodiment of a chip;

FIG. 2 is a schematic layout outline diagram of an embodiment of a circuit unit as a buffer;

FIG. 3 is a schematic outline diagram of a circuit in FIG. 2;

FIG. 4 is a schematic layout outline diagram of an embodiment in which a configurable stage is connected in parallel to an output stage;

FIG. 5 is a schematic outline diagram of a circuit in FIG. 4;

FIG. 6 is a schematic layout outline diagram of an embodiment in which three configurable stages are connected in parallel to an output stage;

FIG. 7 is a schematic outline diagram of a circuit in FIG. 6;

FIG. 8 is a schematic layout outline diagram of an embodiment in which five configurable stages are connected in parallel to an output stage;

FIG. 9 is a schematic outline diagram of a circuit in FIG. 8;

FIG. 10 is a schematic layout outline diagram of an embodiment in which seven configurable stages are connected in parallel to an output stage; and

FIG. 11 is a schematic outline diagram of a circuit in FIG. 10.

### DETAILED DESCRIPTION

To make the objectives, features, and advantages of the embodiments of the disclosure more comprehensible, the following provides detailed descriptions with reference to the accompanying drawings.

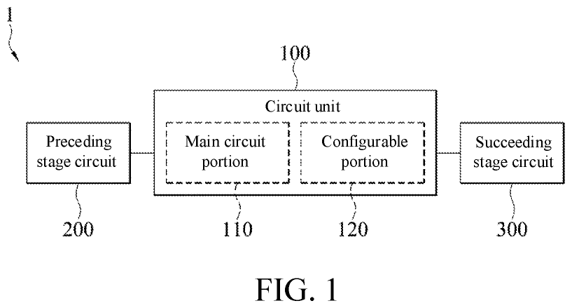

FIG. 1 is a schematic block outline diagram of an embodiment of a chip. Referring to FIG. 1, the chip 1 includes at least one circuit unit 100 having an adjustable driving strength capability. The following uses one circuit unit 100 as an example, but the quantity of the circuit units is not limited thereto. In addition, the chip 1 may include other elements, for example, a preceding stage circuit 200 being a preceding stage of the circuit unit 100, a succeeding stage circuit 300 being a succeeding stage of the circuit unit 100, at least one fill unit (not shown) filled to meet a metal density of a layout, or at least one engineer change order (ECO) element (not shown) filled in an unused region, but the disclosure is not limited thereto. In some implementation aspects, because the preceding stage circuit 200 and the succeeding stage circuit 300 are respectively the preceding and succeeding stages of the circuit unit 100, the circuit unit 100 is usually arranged adjacent to the preceding stage circuit 200 and the succeeding stage circuit 300 in a layout. In addition, to enable connection wires between the circuits to be closer, the at least one ECO element is arranged in an outer region outside the circuits connected to each other.

The circuit unit 100 includes a main circuit portion 110 and a configurable portion 120. The circuit unit 100 has a circuit function, and the main circuit portion 110 and the configurable portion 120 are configured to jointly implement the circuit function of the circuit unit 100. The following uses an example in which the circuit unit 100 is a buffer, and the main circuit portion 110 and the configurable portion 120 are configured to jointly implement a buffer function of the circuit unit 100 for description, but the disclosure is not limited thereto. In some embodiments, because the buffer may include a two-stage inverter, the main circuit portion 110 of the circuit unit 100 may form a one-stage inverter, and the configurable portion 120 of the circuit unit 100 may form the other one-stage inverter, to jointly implement the function of the buffer.

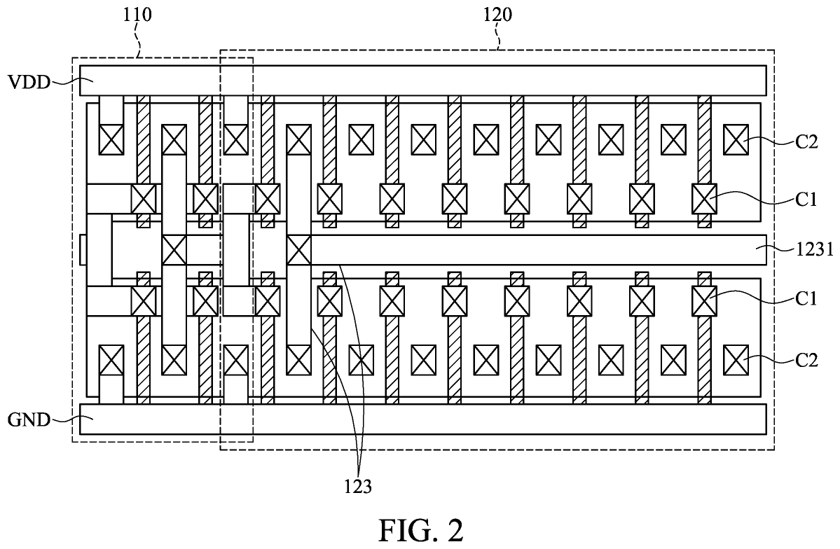

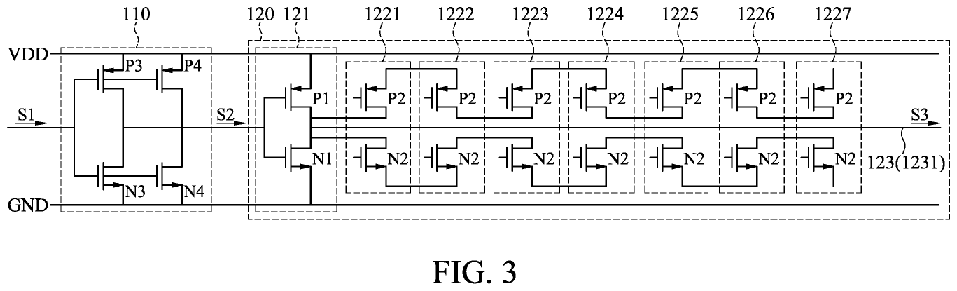

FIG. 2 is a schematic layout outline diagram of an embodiment of a circuit unit as a buffer, and FIG. 3 is a schematic outline diagram of a circuit in FIG. 2. Referring to FIG. 1 to FIG. 3, the main circuit portion 110 is adjacent to and connected to the configurable portion 120. The configurable portion 120 includes an output stage 121, a plurality of configurable stages 1221-1227 (the quantity of seven is used as an example, but the quantity is not limited thereto), and a configurable metal layer 123. In a preferable implementation aspect, a layout arrangement of the output stage 121 and the plurality of configurable stages 1221-1227 adopts a regular arrangement manner (as shown in FIG. 2), so that a metal connection wire of the output stage 121 and the plurality of configurable stages 1221-1227 is of a straight type and the metal connection wire may adopt a wire connection manner with a shorter length.

The main circuit portion 110 may be configured to receive an input signal S1 and generate an intermediate signal S2 according to the input signal S1. In some embodiments, the main circuit portion 110 may include a P-type transistor P3 and an N-type transistor N3. A gate terminal of the P-type transistor P3 and a gate terminal of the N-type transistor N3 may be connected through a metal wire to receive the input signal S1. In some implementation aspects, the input signal S1 may be from the preceding stage circuit 200. A source terminal of the P-type transistor P3 may be connected to a power supply metal wire VDD through a metal wire, a drain terminal of the P-type transistor P3 may be connected to a drain terminal of the N-type transistor N3 through a metal wire, and a source terminal of the N-type transistor N3 may be connected to a ground wire GND through a metal wire, so that the P-type transistor P3 and the N-type transistor N3 may jointly generate the intermediate signal S2. Herein, because the main circuit portion 110 forms the one-stage inverter, the intermediate signal S2 is inverted to the input signal S1, but the disclosure is not limited thereto.

In some embodiments, the main circuit portion 110 may further include at least one P-type transistor P4 connected in parallel to the P-type transistor P3 through a metal wire, and at least one N-type transistor N4 connected in parallel to the N-type transistor N3 through a metal wire, to increase a driving strength of the main circuit portion 110 to the output stage 121. Herein, although only one P-type transistor P4 and one N-type transistor N4 are shown, the quantity is not limited thereto.

The main circuit portion 110 is adjacent to the output stage 121 of the configurable portion 120, and the main circuit portion 110 is connected to the output stage 121 of the configurable portion 120 to output the intermediate signal S2 to the output stage 121. The output stage 121 is configured to generate an output signal S3 according to the intermediate signal S2. In some embodiments, the output stage 121 may include a first P-type transistor P1 and a first N-type transistor N1. The first P-type transistor P1 has a first control terminal (a gate), a first connection terminal (a source), and a second connection terminal (a drain). The first N-type transistor N1 has a second control terminal (a gate), a third connection terminal (a drain), and a fourth connection terminal (a source).

The first control terminal of the first P-type transistor P1 of the output stage 121 and the second control terminal of the first N-type transistor N1 may be connected through a metal wire and connected to the drain terminal of the P-type transistor P3 and the drain terminal of the N-type transistor N3 of the main circuit portion 110, to receive the intermediate signal S2 generated by the main circuit portion 110. The first connection terminal of the first P-type transistor P1 may be connected to the power wire VDD through a metal wire. In addition, the fourth connection terminal of the first N-type transistor N1 may be connected to the ground wire GND through a metal wire.

In some embodiments, to save layout area, the main circuit portion 110 and the configurable portion 120 that are connected may partially overlap in the layout. For example, as shown in FIG. 2, the source terminal of the P-type transistor P4 of the main circuit portion 110 and the first connection terminal of the adjacent first P-type transistor P1 of the output stage 121 may directly overlap by being both connected to (that is, in contact with) the power wire VDD, and the source terminal of the N-type transistor N4 of the main circuit portion 110 and the fourth connection terminal of the adjacent first N-type transistor N1 of the output stage 121 may directly overlap by being both connected to (that is, in contact with) the ground wire GND. It should be noted that this is a layout skill, and therefore other similar aspects in the disclosure may be processed accordingly and are not described again.

The configurable metal layer 123 is connected to the output stage 121, so that the output signal S3 generated by the output stage 121 may be output through the configurable metal layer 123. Herein, the configurable metal layer 123 is connected to the second connection terminal of the first P-type transistor P1 and the third connection terminal of the first N-type transistor N1, so that the first P-type transistor P1 and the first N-type transistor N1 may jointly generate the output signal S3. Herein, because the output stage 121 and the configurable metal layer 123 form the one-stage inverter, the output signal S3 is inverted to the intermediate signal S2, but the disclosure is not limited thereto.

In some implementation aspects, the configurable metal layer 123 may be a single metal layer, for example, but not limited to, Metal 2. However, the disclosure is not limited thereto. The configurable metal layer 123 may alternatively be a multi-metal layer, for example, but not limited to, Metal 1/Metal 2 or Metal 1/Metal 2/Metal 3. When the configurable metal layer 123 is the multi-metal layer, each metal layer of the configurable metal layer may connect to another metal layer through a metal-to-metal via. In addition, the configurable metal layer 123 and the metal wires described in the disclosure may be metal of the same layer and/or different layers.

Herein, the main circuit portion 110, the output stage 121, and the configurable metal layer 123 already can jointly implement the circuit function, that is, the buffer function, of the circuit unit 100. The circuit unit 100 has a driving strength, and the driving strength is related to a drive capability of the output stage 121.

The circuit unit 100 itself includes a plurality of configurable stages 1221-1227, and the plurality of configurable stages 1221-1227 are configured to provide a plurality of driving strength options for the circuit unit 100. In other words, a larger quantity of the configurable stages 1221-1227 indicates a larger quantity of the driving strength options provided for the circuit unit 100. Herein, the plurality of configurable stages 1221-1227 may be sequentially connected to the output stage 121. It should be noted that these configurable stages 1221-1227 connected to the output stage 121 do not affect the circuit function of the circuit unit 100. These configurable stages 1221-1227 may be used during subsequent revision of the chip 1, so that a designer can directly adjust the driving strength of the circuit unit 100 through the reconfiguration of the configurable metal layer 123. The revision may refer to debugging, modification, fine adjustment, and adding an additional function to a certain circuit inside the chip 1 after the chip 1 is tape-out. Because the circuit unit 100 itself has a plurality of configurable stages 1221-1227, when the chip 1 is subsequently revised, the drive capability of the circuit unit 100 may be adjusted by simply changing a mask corresponding to the configurable metal layer 123 without changing a mask corresponding to the other layers, which has a higher cost-effectiveness. In addition, because the circuit unit 100 itself has a plurality of configurable stages 1221-1227, there is no need to use the ECO element located in a quite peripheral region.

In some embodiments, when the chip 1 is revised, the designer may connect at least one of the configurable stages 1221-1227 in parallel to the output stage 121 through the configurable metal layer 123, to increase the driving strength of the circuit unit 100.

It should be noted that the disclosure does not limit that the configurable stages 1221-1227 are connected in parallel to the output stage 121 through the configurable metal layer 123 only in the revised chip 1. In other words, in the chip 1 of the first version, there may also be at least one of the configurable stages 1221-1227 connected in parallel to the output stage 121 through the configurable metal layer 123.

In some embodiments, the driving strengths that may be provided by the configurable stages 1221-1227 are substantially the same or proportional (for example: 1:2:4:8), to facilitate setting the required driving strength. In some embodiments, a size of each of the configurable stages 1221-1227 is substantially the same. The size may be, but is not limited to, a channel length of the transistor, a W/L ratio, a threshold voltage, or a combination thereof. Therefore, by adjusting the quantity of the configurable stages 1221-1227 connected in parallel to the output stage 121 by the configurable metal layer 123, an increased ratio of the driving strength of the circuit unit 100 can be adjusted accordingly. In other embodiments, the sizes of these configurable stages 1221-1227 may be partially the same, partially different, or totally different.

In some embodiments, components of each of the configurable stages 1221-1227 are accordingly arranged to be substantially the same or similar to components of the output stage 121, and the sizes of the output stage 121 and these configurable stages 1221-1227 may be partially the same, partially different, or totally different. For example, when the output stage 121 includes one N-type transistor and one P-type transistor, each of the configurable stages 1221-1227 also includes one N-type transistor and one P-type transistor.

Herein, when the output stage 121 includes one first P-type transistor P1 and one first N-type transistor N1, each of the configurable stages 1221-1227 accordingly includes one second P-type transistor P2 and one second N-type transistor N2. Each second P-type transistor P2 has a third control terminal (a gate), a fifth connection terminal (a source), and a sixth connection terminal (a drain). Each second N-type transistor N2 includes a fourth control terminal (a gate), a seventh connection terminal (a drain), and an eighth connection terminal (a source).

In some embodiments, the fifth connection terminal (or the sixth connection terminal) of the second P-type transistor P2 of the configurable stage 1221 may be connected to the fifth connection terminal (or the sixth connection terminal) of the second P-type transistor P2 of the configurable stage 1222, the sixth connection terminal (or the fifth connection terminal) of the second P-type transistor P2 of the configurable stage 1222 is connected to the sixth connection terminal (or the fifth connection terminal) of the second P-type transistor P2 of the configurable stage 1223. According to this rule, the configurable stages 1221-1227 may be sequentially connected to the first connection terminal (or the second connection terminal) of the first P-type transistor P1 of the output stage 121. Herein, the sixth connection terminal of the second P-type transistor P2 of the configurable stage 1221 is connected to the second connection terminal of the first P-type transistor P1 of the output stage 121, the fifth connection terminal of the second P-type transistor P2 of the configurable stage 1221 is connected to the fifth connection terminal of the second P-type transistor P2 of the configurable stage 1222, and the sixth connection terminal of the second P-type transistor P2 of the configurable stage 1222 is connected to the sixth connection terminal of the second P-type transistor P2 of the configurable stage 1223. According to this rule, the second P-type transistors P2 of the configurable stages 1221-1227 are sequentially connected to the second connection terminal of the first P-type transistor P1 of the output stage 121.

Similarly, in some embodiments, referring to the foregoing connection manner of the second P-type transistor P2, the second N-type transistor N2 of each of the configurable stages 1221-1227 may be connected to each other by the seventh connection terminal or the eighth connection terminal and connected to the third connection terminal or the fourth connection terminal of the first N-type transistor N1 of the output stage 121. Herein, the seventh connection terminal of the second N-type transistor N2 of the configurable stage 1221 is connected to the third connection terminal of the first N-type transistor N1 of the output stage 121, the eighth connection terminal of the second N-type transistor N2 of the configurable stage 1221 is connected to the eighth connection terminal of the second N-type transistor N2 of the configurable stage 1222, and the seventh connection terminal of the second N-type transistor N2 of the configurable stage 1222 is connected to the seventh connection terminal of the second N-type transistor N2 of the configurable stage 1223. According to this rule, the second N-type transistors N2 of the configurable stages 1221-1227 are sequentially connected to the third connection terminal of the first N-type transistor N1 of the output stage 121. Through the foregoing manner, the plurality of configurable stages 1221-1227 may be sequentially connected to the output stage 121.

In some embodiments, a metal-to-polysilicon contact C1 may be arranged on the third control terminal of the second P-type transistor P2 and the fourth control terminal of the second N-type transistor N2 of each of the configurable stages 1221-1227 respectively in the layout, to facilitate the direct connection to the configurable metal layer 123. Similarly, a metal-to-silicon contact C2 may be arranged on the fifth connection terminal and the sixth connection terminal of the second P-type transistor P2 and the seventh connection terminal and the eighth connection terminal of the second N-type transistor N2 of each of the configurable stages 1221-1227 respectively, to facilitate the direct connection to the configurable metal layer 123. In this way, because the configurable stages 1221-1227 include the corresponding metal-to-polysilicon contact for connection to the configurable metal layer 123, there is no need to change a corresponding mask when the contact C1 and the contact C2 need to be arranged during the subsequent revision, which has a higher cost-effectiveness.

In some implementation aspects, the layout of the circuit unit 100 with a basic driving strength (that is, none of the configurable stages 1221-1227 connected to the output stage 121 in parallel) may be shown in FIG. 2. In the layout, the circuit unit 100 may be roughly a rectangular unit. The power wire VDD and the ground wire GND are horizontally configured above and below the rectangular unit along a long axis of the rectangular unit respectively. The P-type transistors P3-P4, the first P-type transistor P1, and the second P-type transistor P2 are sequentially concatenated below the power wire VDD from left to right along the long axis of the rectangular unit, and are adjacent to the power wire VDD. The N-type transistors N3-N4, the first N-type transistor N1, and the second N-type transistor N2 are sequentially concatenated above the ground wire GND from left to right along the long axis of the rectangular unit, and are adjacent to the ground wire GND. The contact C1 is arranged on the gate terminals of the P-type transistors P3 and P4, the first control terminal of the first P-type transistor P1, the third control terminal of the second P-type transistor P2, the gate terminal of the N-type transistors N3 and N4, the second control terminal of the first N-type transistor N1, and the fourth control terminal of the second N-type transistor N2 respectively. The contact C2 is arranged on the source terminal and the drain terminal of the P-type transistors P3 and P4, the first connection terminal and the second connection terminal of the first P-type transistor P1, the fifth connection terminal and the sixth connection terminal of the second P-type transistor P2, the source terminal and the drain terminal of the N-type transistors N3 and N4, the third connection terminal and the fourth connection terminal of the first N-type transistor N1, and the seventh connection terminal and the eighth connection terminal of the second N-type transistor N2 respectively.

The gate terminal of the P-type transistor P3 may be connected to the contact C1 of the gate terminal of the P-type transistor P4 through a horizontal metal wire parallel to the long axis of the rectangular unit, the gate terminal of the N-type transistor N3 may be connected to the contact C1 of the gate terminal of the N-type transistor N4 through the horizontal metal wire, and the gate terminal of the P-type transistor P3 is further connected to the contact C1 of the gate terminal of the N-type transistor N3 through a vertical metal wire parallel to a short axis of the rectangular unit. A metal wire connected between the gate terminal of the P-type transistor P3 and the gate terminal of the N-type transistor N3 may be roughly C-shaped and used for receiving the input signal S1. The source terminal of the P-type transistor P3 and the first connection terminal of the first P-type transistor P1 are connected to the power wire VDD through a vertical metal wire. The source terminal of the N-type transistor N3 and the fourth connection terminal of the first N-type transistor N1 are connected to the ground wire GND through a vertical metal wire. The drain terminal of the P-type transistor P3 is connected to the contact C2 of the drain terminal of the N-type transistor N3 through a vertical metal wire. The first control terminal of the first P-type transistor P1 is connected to the second control terminal of the first N-type transistor N1 through a roughly C-shaped metal wire, and the C-shaped metal wire is further connected to the vertical metal wire connected between the drain terminal of the P-type transistor P3 and the drain terminal of the N-type transistor N3, to receive the intermediate signal S2. The configurable metal layer 123 is connected to the second connection terminal of the first P-type transistor P1 and the third connection terminal of the first N-type transistor N1 through a vertical wire, and is then pulled out through a horizontal output wire 1231, to output an output signal S3. Herein, the entire circuit unit 100 may be arranged roughly in a symmetry layout manner. For example, the entire circuit unit 100 may have a symmetry line (for example, the long axis passing through the center of the rectangular unit) and be longitudinal symmetry. In another example, the layout of the output stage 121 and the plurality of configurable stages 1221-1227 is arranged in a longitudinal symmetry layout manner with an output wire 1231 of the configurable metal layer 123 as a symmetry line. The size of the each of the configurable stages 1221-1227 may be different because of the different driving strengths. Therefore, the so-called symmetry refers to the symmetry of the layout, and is not limited to the symmetry of the size.

It should be noted that the layout aspect of the circuit unit 100 as the buffer is not limited to the layout aspect shown in FIG. 2 in the disclosure. In fact, the layout may be implemented in various ways, and any simple changes and modifications (for example, the overlapping layout part is changed to a non-overlapping part and be connected with another layer) shall fall within the scope of the disclosure.

In some embodiments, there may be a first quantity of configurable stages 1221-1227 connected in parallel to the output stage 121 through the configurable metal layer 123. The first quantity is not greater than the total quantity of the configurable stages 1221-1227. The detailed parallel connection manner may be described as follows: the third control terminal, the fifth connection terminal, and the sixth connection terminal of the second P-type transistor P2 of the first quantity of the configurable stages are connected to the first control terminal, the first connection terminal, and the second connection terminal of the first P-type transistor P1 of the output stage 121 through the configurable metal layer 123 respectively, and the fourth control terminal, the seventh connection terminal, and the eighth connection terminal of the second N-type transistor N2 of the first quantity of the configurable stages are connected to the second control terminal, the third connection terminal, and the fourth connection terminal of the first N-type transistor N1 of the output stage 121 through the configurable metal layer 123 respectively. In other words, there are the first quantity of the second P-type transistors P2 connected in parallel to the first P-type transistor P1, and the first quantity of second N-type transistors N2 connected in parallel to the first N-type transistor N1.

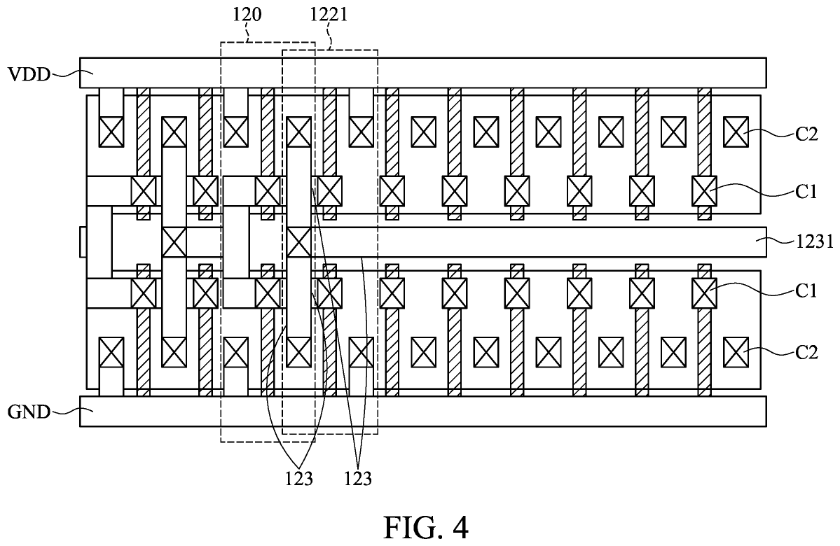

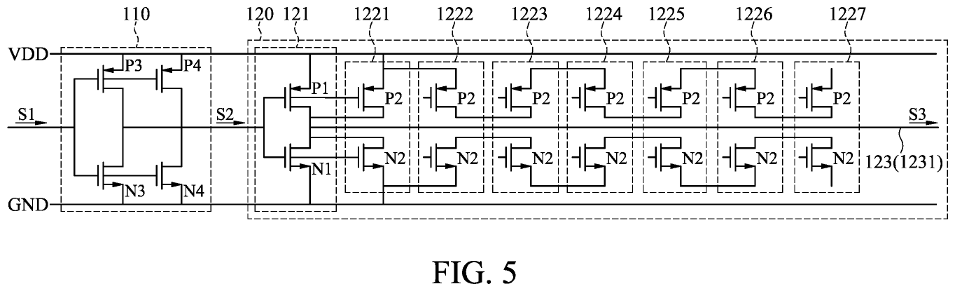

Referring to FIG. 4 to FIG. 11, in some implementation aspects, the layout aspect of the one configurable stage 1221 connected in parallel to the output stage 121 through the configurable metal layer 123 may be shown in FIG. 4, and the corresponding circuit aspect may be shown in FIG. 5. As shown in FIG. 4, compared with the aspect shown in FIG. 2, the contact C1 of the third control terminal of the second P-type transistor P2 of the configurable stage 1221 may be easily connected to the contact C1 of the first control terminal of the first P-type transistor P1 of the output stage 121 through a horizontal wire of the configurable metal layer 123, the contact C1 of the fourth control terminal of the second N-type transistor N2 of the configurable stage 1221 is connected to the contact C1 of the second control terminal of the first N-type transistor N1 of the output stage 121 through a horizontal wire of the configurable metal layer 123, the contact C2 of the fifth connection terminal of the second P-type transistor P2 of the configurable stage 1221 is connected to the power wire VDD through a vertical wire of the configurable metal layer 123, and the contact C2 of the eighth connection terminal of the second N-type transistor N2 of the configurable stage 1221 is connected to the ground wire GND through a vertical wire of the configurable metal layer 123, so that the configurable stage 1221 is connected in parallel to the output stage 121.

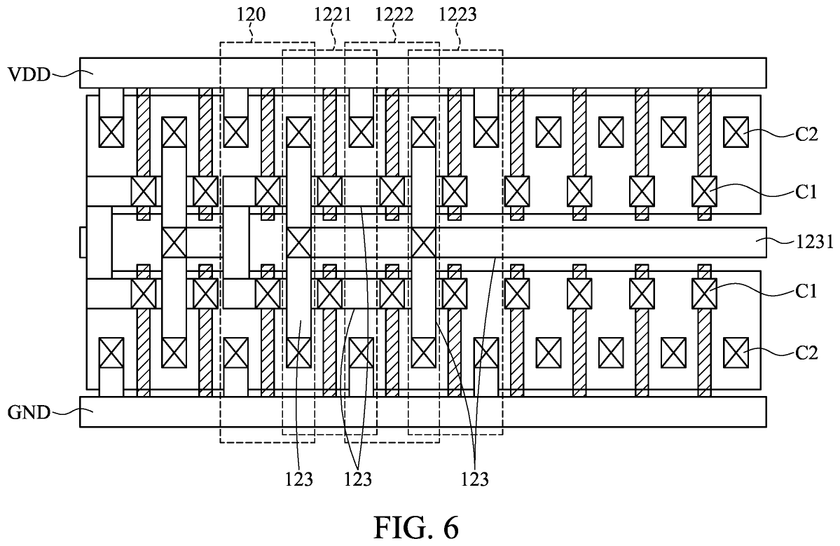

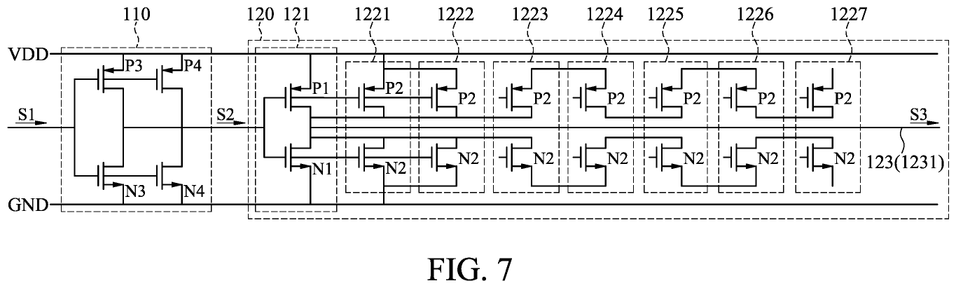

In some implementation aspects, the layout aspect of the three configurable stages 1221-1223 connected in parallel to the output stage 121 through the configurable metal layer 123 may be shown in FIG. 6, and the corresponding circuit aspect may be shown in FIG. 7. As shown in FIG. 6, compared with FIG. 4, the contact C1 of the third control terminal of the second P-type transistor P2 of the configurable stages 1222 and 1223 may be connected to the contact C1 of the third control terminal of the second P-type transistor P2 of the configurable stage 1221 through a horizontal wire of the configurable metal layer 123, the contact C1 of the fourth control terminal of the second N-type transistor N2 of the configurable stages 1222 and 1223 is connected to the contact C1 of the fourth control terminal of the second N-type transistor N2 of the configurable stage 1221 through a horizontal wire of the configurable metal layer 123, the contact C2 of the sixth connection terminal of the second P-type transistor P2 of the configurable stage 1222 is connected to the contact C2 of the seventh connection terminal of the second N-type transistor N2 of the configurable stage 1222 through a vertical wire of the configurable metal layer 123, and the vertical wire is connected to the output wire 1231 through a via, the contact C2 of the fifth connection terminal of the second P-type transistor P2 of the configurable stage 1223 is connected to the power wire VDD through a vertical wire of the configurable metal layer 123, and the contact C2 of the eighth connection terminal of the second N-type transistor N2 of the configurable stages 1222 and 1223 is connected to the ground wire GND through a vertical wire of the configurable metal layer 123, so that the configurable stages 1222 and 1223 are also connected in parallel to the output stage 121 along with the configurable stage 1221.

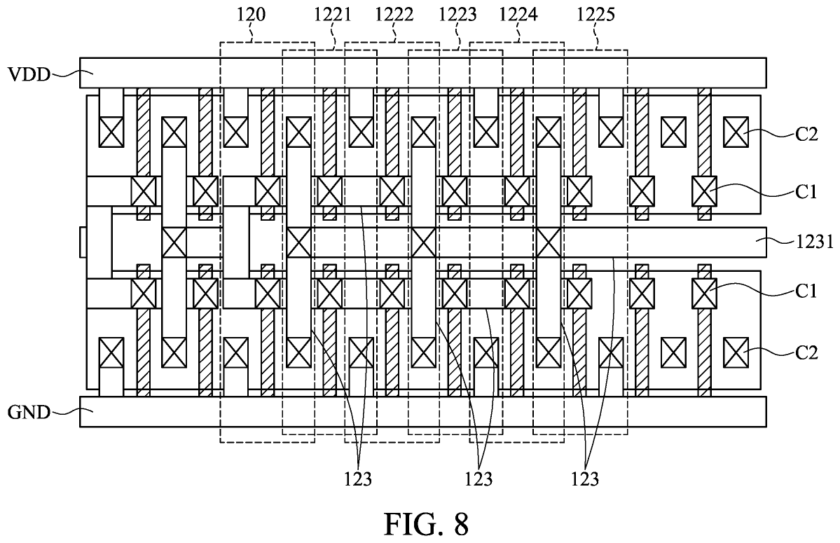

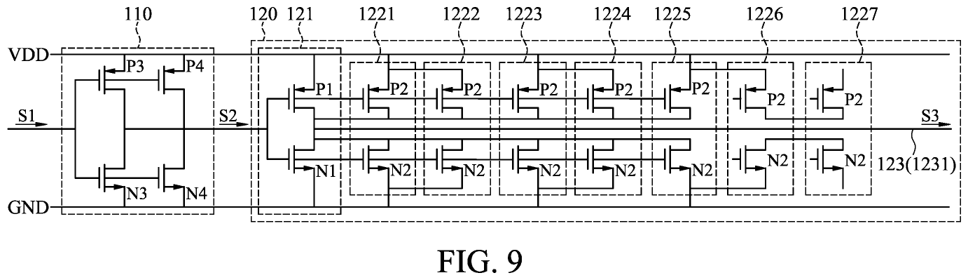

In some implementation aspects, the layout aspect of the five configurable stages 1221-1225 connected in parallel to the output stage 121 through the configurable metal layer 123 may be shown in FIG. 8, and the corresponding circuit aspect may be shown in FIG. 9.

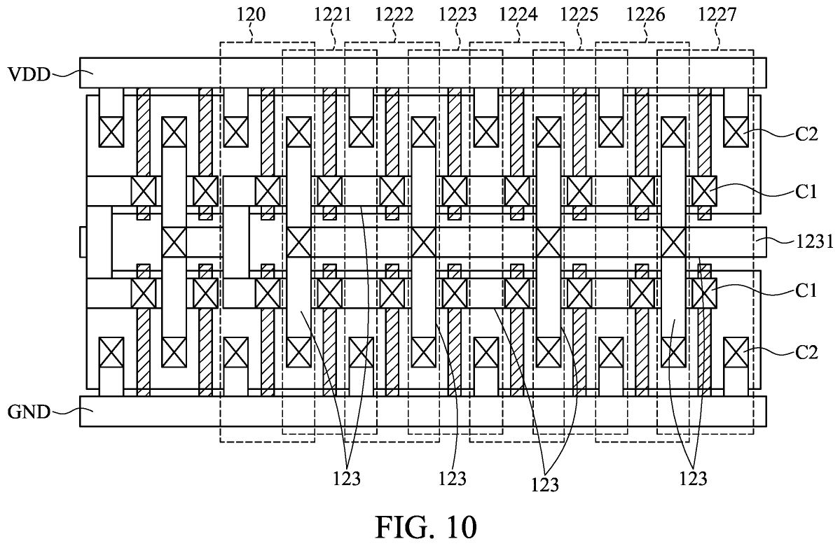

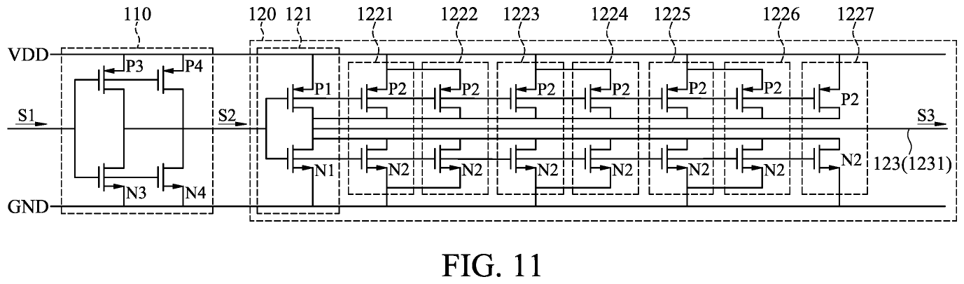

In some implementation aspects, the layout aspect of the all configurable stages 1221-1227 connected in parallel to the output stage 121 through the configurable metal layer 123 may be shown in FIG. 10, and the corresponding circuit aspect may be shown in FIG. 11. As shown in FIG. 10, compared with FIG. 8, the contact C1 of the third control terminal of the second P-type transistor P2 of the configurable stages 1226 and 1227 may be connected to the contact C1 of the third control terminal of the second P-type transistor P2 of the configurable stage 1225 through a horizontal wire of the configurable metal layer 123, the contact C1 of the fourth control terminal of the second N-type transistor N2 of the configurable stages 1226 and 1227 is connected to the contact C1 of the fourth control terminal of the second N-type transistor N2 of the configurable stage 1225 through a horizontal wire of the configurable metal layer 123, the contact C2 of the sixth connection terminal of the second P-type transistor P2 of the configurable stage 1226 is connected to the contact C2 of the seventh connection terminal of the second N-type transistor N2 of the configurable stage 1226 through a vertical wire of the configurable metal layer 123, and the vertical wire is connected to the output wire 1231 through a via, the contact C2 of the fifth connection terminal of the second P-type transistor P2 of the configurable stage 1227 is connected to the power wire VDD through a vertical wire of the configurable metal layer 123, and the contact C2 of the eighth connection terminal of the second N-type transistor N2 of the configurable stages 1226 and 1227 is connected to the ground wire GND through a vertical wire of the configurable metal layer 123, so that the configurable stages 1226 and 1227 are also connected in parallel to the output stage 121 along with the configurable stages 1221-1225.

It can be learned from the foregoing paragraphs that, different driving strengths can be achieved by only modifying the configuration of one configurable metal layer 123, and a length of the output wire 1231 of the configurable metal layer 123 does not substantially increase (change) due to the modification of the configuration of the configurable metal layer 123, so that the entire layout path can still meet the timing requirement needed before the revision.

In some embodiments, the circuit unit 100 may be a circuit of various types, for example, but not limited to, an inverter, a trigger, or a logic circuit. The main circuit portion 110, the output stage 121 of the configurable portion 120, and the configurable metal layer 123 are a portion of a specific circuit respectively, and the main circuit portion 110, the output stage 121 of the configurable portion 120, and the configurable metal layer 123 can jointly implement the circuit function of the specific circuit. For example, when the circuit unit 100 is an OR gate, the main circuit portion 110 may be a NOR gate, and the output stage 121 of the configurable portion 120 and the configurable metal layer 123 may form an inverter, to jointly implement the function of the NOR gate. In another example, when the circuit unit 100 is a NAND gate, the main circuit portion 110 may be a portion of the NAND gate, and the output stage 121 of the configurable portion 120 and the configurable metal layer 123 may form the other portion of the NAND gate and may jointly implement the function of the NAND gate.

In some embodiments, a method for determining a driving strength of a circuit unit includes: providing a main circuit portion of the circuit unit; providing a configurable portion of the circuit unit, wherein the configurable portion comprises an output stage, a plurality of configurable stages, and a configurable metal layer, and wherein the configurable stages are configured to be connected in sequence to the output stage, and the configurable metal layer is connected to the output stage; wherein the main circuit portion is configured to be adjacent to and connected to the output stage of the configurable portion; and determining the driving strength of the circuit unit according to a connection relationship between each of the configurable stages and the configurable metal layer.

In conclusion, the circuit unit having an adjustable driving strength capability in a chip and method thereof of the embodiments of the disclosure includes at least one configurable portion. In the configurable portion of the circuit unit, the plurality of configurable stages are sequentially connected to the output stage, and these configurable stages may be configured to adjust the driving strength of the circuit unit through the configurable metal layer. In addition, during the subsequent revision of the chip, the drive capability of the circuit unit can be adjusted by simply changing the mask corresponding to the configurable metal layer, which has a high cost-effectiveness.

Although the disclosure has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A circuit unit in a chip, comprising:
a main circuit portion; and
a configurable portion, comprising an output stage, a plurality of configurable stages, and a configurable metal layer, wherein the configurable stages are configured to be connected in sequence to the output stage, and the configurable metal layer is connected to the output stage;
wherein the main circuit portion is configured to be adjacent to and connected to the output stage of the configurable portion; and
wherein a driving strength of the circuit unit is determined based on a connection relationship between each of the configurable stages and the configurable metal layer.

2. The circuit unit according to claim 1, wherein at least one of the configurable stages is not connected to the output stage through the configurable metal layer.

3. The circuit unit according to claim 1, wherein at least one of the configurable stages is connected in parallel to the output stage through the configurable metal layer, to increase the driving strength of the circuit unit.

4. The circuit unit according to claim 3, wherein at least one of the configurable stages is not connected to the output stage through the configurable metal layer.

5. The circuit unit according to claim 1, wherein components of each of the configurable stages are substantially the same as components of the output stage.

6. The circuit unit according to claim 5, wherein the output stage comprises:
a first P-type transistor, having a first control terminal, a first connection terminal, and a second connection terminal; and
a first N-type transistor, having a second control terminal, a third connection terminal, and a fourth connection terminal; and
each of the configurable stages comprises:
a second P-type transistor, having a third control terminal, a fifth connection terminal, and a sixth connection terminal; and
a second N-type transistor, having a fourth control terminal, a seventh connection terminal, and an eighth connection terminal;
wherein the fifth connection terminals and the sixth connection terminals of the second P-type transistor of the configurable stages are respectively connected to each other; and
wherein the seventh connection terminals and the eighth connection terminals of the second N-type transistor of the configurable stages are respectively connected to each other;
wherein the configurable metal layer is connected to the third connection terminal and the second connection terminal of at least one of the configurable stages.

7. The circuit according to claim 6, wherein the first connection terminal of the first P-type transistor is connected to a power wire of the chip, the fourth connection terminal of the first N-type transistor is connected to a ground wire of the chip, and the first control terminal of the first P-type transistor is connected to the second control terminal of the first N-type transistor.

8. The circuit unit according to claim 1, wherein structure of each of the configurable stages is substantially the same.

9. The circuit unit according to claim 1, wherein a layout of the output stage and the plurality of configurable stages is arranged in a symmetry layout manner.

10. The circuit unit according to claim 1, wherein a layout of the output stage and the plurality of configurable stages is arranged in a symmetry layout manner with an output wire of the configurable metal layer as a symmetry line.

11. The circuit unit according to claim 1, wherein a layout arrangement of the output stage and the plurality of configurable stages adopts a regular arrangement manner.

12. The circuit unit according to claim 1, wherein a layout arrangement of the output stage and the plurality of configurable stages causes an output wire of the configurable metal layer to be in a straight shape.

13. The circuit unit according to claim 1, wherein driving strengths of the plurality of configurable stages are substantially the same.

14. The circuit unit according to claim 1, wherein driving strengths of the plurality of configurable stages are substantially at least partly different, and the driving strengths of the plurality of configurable stages have a fixed proportional relationship.

15. A method for determining a driving strength of a circuit unit, the method comprising:
providing a main circuit portion of the circuit unit;
providing a configurable portion of the circuit unit,
wherein the configurable portion comprises an output stage, a plurality of configurable stages, and a configurable metal layer, and
wherein the configurable stages are configured to be connected in sequence to the output stage, and the configurable metal layer is connected to the output stage;
wherein the main circuit portion is configured to be adjacent to and connected to the output stage of the configurable portion; and
determining the driving strength of the circuit unit according to a connection relationship between each of the configurable stages and the configurable metal layer.

16. The method according to claim 15, wherein a layout of the output stage and the plurality of configurable stages is arranged in a symmetry layout manner.

17. The method according to claim 15, wherein a layout arrangement of the output stage and the plurality of configurable stages adopts a regular arrangement manner.

18. The method according to claim 15, wherein a layout arrangement of the output stage and the plurality of configurable stages causes an output wire of the configurable metal layer to be in a straight shape.

19. The method according to claim 15, wherein the driving strength of each of the configurable stages are substantially the same.

20. The method according to claim 15, wherein driving strengths of the plurality of configurable stages are substantially at least partly different, and the driving strengths of the plurality of configurable stages have a fixed proportional relationship.
